(19) United States
(12) Patent Application Publication
(10) Pub. No.: US 2015/0172544 A1
(43) Pub. Date: Jun. 18, 2015

(54) PANORAMA BASED 3D VIDEO CODING

(71) Applicants: Zhipin Deng, Beijing (CN); Jianguo Li, Beijing (CN); Lidong Xu, Beijing (CN); Hong Jiang, El Dorado Hills, CA (US)

(72) Inventors: Zhipin Deng, Beijing (CN); Jianguo Li, Beijing (CN); Lidong Xu, Beijing (CN); Hong Jiang, El Dorado Hills, CA (US)

(21) Appl. No.: 13/977,426

(22) PCT Filed: Jul. 4, 2012
(86) PCT No.: PCT/CN2012/078158

§ 371 Date: Oct. 11, 2013

(51) Int. Cl. H04N 5/232; H04N 19/44; H04N 19/597; H04N 13/00; H04N 13/04

(52) U.S. Cl. CPC H04N 5/23238; H04N 13/0048; H04N 13/0402; H04N 19/597; H04N 19/44

(57) ABSTRACT

Systems, apparatus, articles, and methods are described including operations for panorama based 3D video coding.

### BACKGROUND

A video encoder compresses video information so that more information can be sent over a given bandwidth. The compressed signal may then be transmitted to a receiver that decodes or decompresses the signal prior to display.

3D video has become an emerging medium that can offer a richer visual experience than traditional 2D video. Potential applications include free-viewpoint video (FVV), free-viewpoint television (FTV), 3D television (3DTV), IMAX theaters, immersive teleconferences, surveillance, etc. To support these applications, video systems typically capture a scene from different viewpoints, which results in generating several video sequences from different cameras simultaneously.

3D Video Coding (3DVC) refers to a new video compress standard that targets serving a variety of 3D displays. 3DVC is under development by the ISO/IEC Moving Picture Experts Group (MPEG). At present, one of the branches of 3DVC is built based on the latest conventional video coding standard, High Efficient Video Coding (HEVC), which is planned to be finalized by the end of 2012. The other branch of 3DVC is built based on the H.264/AVC.

The ISO/IEC Moving Picture Experts Group (MPEG) is now undertaking the standardization of 3D Video Coding (3DVC). The new 3DVC standard will likely enable the generation of many high-quality views from a limited amount of input data. For example, a Multiview Video plus Depth (MVD) concept may be used to generate such high-quality views from a limited amount of input data. Further, 3DVC may be utilized for advanced stereoscopic processing functionality and to support auto-stereoscopic display and FTV that allows users to have a 3D visual experience while freely changing their position in front of a 3D display.

Generally, there are two main components of Multiview Video plus Depth (MVD) concept that support the FTV functionality, multiview video and associate depth map information. Such multiview video typically refers to a scene being captured by many cameras and from different view positions. Such associate depth map information typically refers to each texture view being associated with a depth map that tells how far from the camera the objects in the scene are. From the multiview video and depth information, virtual views can be generated at an arbitrary viewing position.

The Multiview Video plus Depth (MVD) concept is often used to represent the 3D video content, in which a number of views and associated depth maps are typically coded and multiplexed into a bitstream. Camera parameters of each view are also typically packed into the bitstream for the purpose of view synthesis. One of the views, which are also typically referred to as the base view or the independent view, is typically coded independently of the other views. For the dependent views, video and depth can be predicted from the pictures of other views or previously coded pictures in the same view. According to the specific application, sub-bitstreams can be extracted at the decoder side by discarding non-required bitstream packets.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example 3D video coding system;

FIG. 2 is an illustrative diagram of an example 3D video coding system;

FIG. 3 is a flow chart illustrating an example 3D video coding process;

FIG. 4 is an illustrative diagram of an example 3D video coding process in operation;

FIG. 5 is an illustrative diagram of example panorama based 3D video coding flow;

FIG. 6 is an illustrative diagram of an example 3D video coding system;

FIG. 7 is an illustrative diagram of an example system; and

FIG. 8 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations for panorama based 3D video coding.

As described above, in some cases, in conventional 3D video compression coding, two or three views and associated depth maps may be coded in a bitstream to support various 3D video applications. At the decoder side, virtual synthesized views at a certain view point can be generated by using the depth image based rendering techniques. In order to be backward compatible with conventional 2D video encoder/decoder, one view of the 3D video may be marked as an independent view and it must be coded independently using a conventional 2D video encoder/decoder. In addition to the independent views, other views may be dependent views that allow not only inter-view prediction to exploit the inter-view redundancy, but also intra-view prediction to exploit the spatial and temporal redundancies in the same view. However, a huge amount of 3D video data surges the required bandwidth in comparison with single view videos. Hence, 3D video data may need to be compressed more efficiently.

As will be described in greater detail below, operations for 3D video coding may utilize a panorama based 3D video coding method, which, in some embodiment, could be fully compatible with conventional 2D video coders. Instead of coding multiple view sequences and associated depth map sequences, only a panorama video sequence and a panorama map may be coded and transmitted. Moreover, any arbitrary field of view can be extracted from such a panorama sequence, and 3D video at any intermediate view point can be derived directly. Such panorama based 3D video coding may improve the coding efficiency and flexibility of 3D video coding systems.

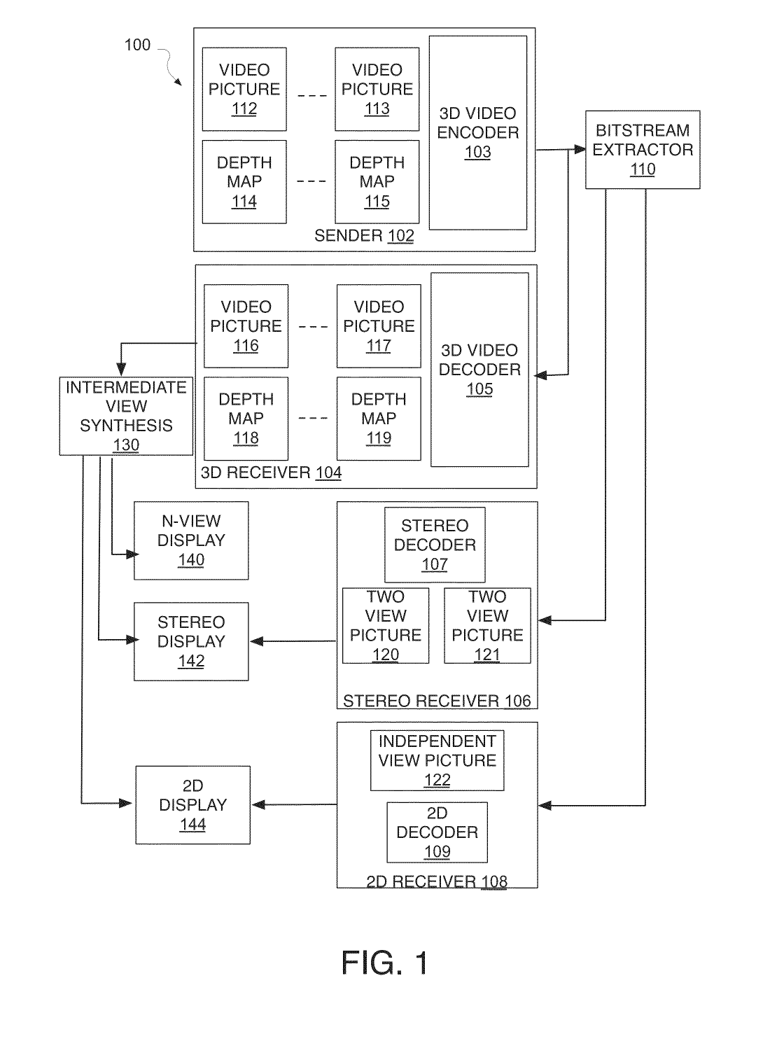

FIG. 1 is an illustrative diagram of an example 3D video coding system 100, arranged in accordance with at least some implementations of the present disclosure. In the illustrated implementation, 3D video coding system 100 may include one or more types of displays (e.g., an N-view display 140, a stereo display 142, a 2D display 144, or the like), one or more imaging devices (not shown), a 3D video encoder 103, a 3D video decoder 105, a stereo video decoder 107, a 2D video decoder 109, and/or a bitstream extractor 110.

In some examples, 3D video coding system 100 may include additional items that have not been shown in FIG. 1 for the sake of clarity. For example, 3D video coding system 100 may include a processor, a radio frequency-type (RF) transceiver, and/or an antenna. Further, 3D video coding system 100 may include additional items such as a speaker, a microphone, an accelerometer, memory, a router, network interface logic, etc. that have not been shown in FIG. 1 for the sake of clarity.

As used herein, the term “coder” may refer to an encoder and/or a decoder. Similarly, as used herein, the term “coding” may refer to encoding via an encoder and/or decoding via a decoder. For example 3D video encoder 103 and 3D video decoder 105 may both be examples of coders capable of 3D coding.

In some examples, a sender 102 may receive multiple views from multiple imaging devices (not shown). The input signal for 3D encoder 103 may include multiple views (e.g., video pictures 112 and 113), associated depth maps (e.g., depth maps 114 and 115), and corresponding camera parameters (not shown). However, 3D video coding system 100 can also be operated without depth data. The input component signals are coded into a bitstream using 3D video encoder 103, in which the base view may be coded using a 2D video encoder, e.g. H264/AVC encoder or High Efficiency Video Coding (HEVC) encoder. If the bitstream from bitstream extractor 110 is decoded by a 3D receiver 104 using 3D video decoder 105, videos (e.g., video pictures 116 and 117), depth data (e.g., depth maps 118 and 119), and/or camera parameters (not shown) may be reconstructed with the given fidelity.

In other examples, if the bitstream from bitstream extractor 110 is decoded by a stereo receiver 106 for displaying the 3D video on an auto stereoscopic display (e.g., stereo display 142), additional intermediate views (e.g., two view pictures 120 and 121) may be generated by a depth-image-based rendering (DIBR) algorithm using the reconstructed views and depth data. If 3D video decoder 103 is connected to a conventional stereo display (e.g., stereo display 142), intermediate view synthesis 130 may also generate a pair of stereo views, in case such a pair is not actually present in the bitstream from bitstream extractor 110.

In further examples, if the bitstream from bitstream extractor 110 is decoded by a 2D receiver 108, one of the decoded views (e.g., independent view picture 122) or an intermediate view at an arbitrary virtual camera position can also be used for displaying a single view on a conventional 2D display (e.g., 2D display 144).

An example of a typical 3DV system for auto-stereoscopic display is shown as FIG. 1. The input signal for the encoder may consist of multiple texture views, associated multiple depth maps, and corresponding camera parameters. It should be noticed that the input data could also be multiple texture views only. When the coded 3D video bitstream is received at the receiver side, the multiple texture views, associated multiple depth maps, and corresponding camera parameters can be fully reconstructed though the 3D video decoder. For displaying the 3D video on an auto stereoscopic display, additional intermediate views are generated via depth-image-based rendering (DIBR) technique using the reconstructed texture views and depth maps.

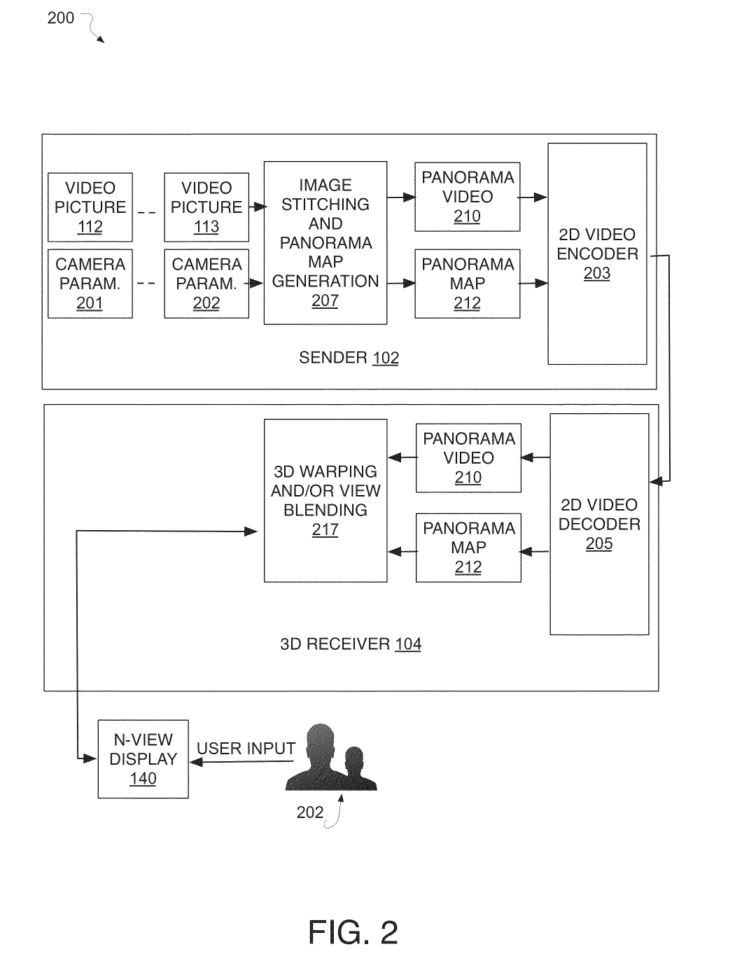

FIG. 2 is an illustrative diagram of an example 2D video coding system 200, arranged in accordance with at least some implementations of the present disclosure. In the illustrated implementation, 2D video coding system 200 may implement operations for panorama based 2D video coding.

As will be described in greater detail below, a panorama video 210 may contain the video content from video picture views 112-113 and the panorama video 210 can be generated by using image stitching algorithms via image stitching and panorama map generation module 207. Note that the video data of multiple video picture views 112-113 can be captured by either parallel camera arrays or arc camera arrays.

The panorama map 212 may contain a series of perspective projection matrix which maps each raw image to the certain region in the panorama video 210, a projection matrix between camera views, and a pixel correspondence (e.g., 6˜7 pixel correspondences) between camera images. The inverse map may realize the map from panorama video 210 to the camera view (e.g., raw images or synthesized views). The panorama map 212 can be constructed via image stitching and panorama map generation module 207 by stable pixel points correspondence (e.g., 6˜7 stable pixel points) between each video picture views 112-113 and panorama video 210; and the camera internal/external parameters 201-202. In order to blend the images to compensate for exposure differences and other misalignments such as illumination changes and ghost phenomenon, view blending techniques for the target region of panorama may be performed when the region comes from several different raw images. The view blending could be put in either the sender side before the 2D video encoder 203 or the receiver side after the 2D video decoder 204, such as part of 3D warping techniques via 3D warping and/or view blending module 217. If the view blending is put in the sender side, the computing may be processed after the generation of panorama video 210 and before the 2D video encoder 203. On the other hand, if it is put in the receiver side, the computing will be processed after the generation of panorama video 210 and before the 3D warping via 3D warping and/or view blending module 217.

2D video coding system 200 may encode the panorama video 210 using a typical 2D video encoder 203, such as MPEG-2, H.264/AVC, HEVC, etc., and the panorama map 212 could be coded and transmitted through MPEG-2 user data syntax, H.264/AVC SEI syntax, or HEVC SEI syntax.

At 3D receiver 104, the panorama video 210 and panorama map 212 can be fully reconstructed by the corresponding 2D video decoder 205. Then arbitrary view video at any intermediate viewing position could be generated through 3D warping techniques via 3D warping and/or view blending module 217. For example, an auto-stereoscopic video can be displayed on display 140, and user 202 may supply input indicating what viewpoint the user desires. In response to the indicated viewpoint, an arbitrary view video at any intermediate viewing position could be generated through 3D warping techniques via 3D warping and/or view blending module 217. As a consequence, an auto-stereoscopic video can be obtained. The random access of an arbitrary view within the input field of multiple views can be efficiently achieved by the panorama based 3D video coding of 2D video coding system 200.

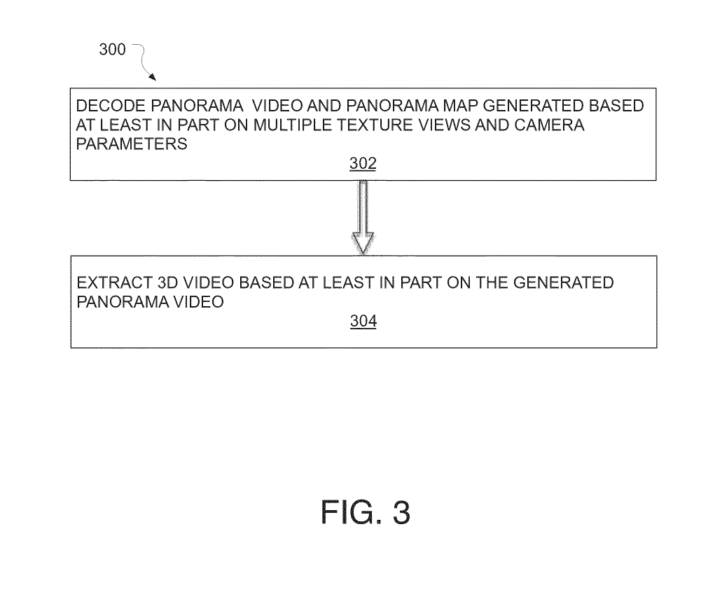

As will be discussed in greater detail below, 3D video coding system 200 may be used to perform some or all of the various functions discussed below in connection with FIGS. 3 and/or 4.

FIG. 3 is a flow chart illustrating an example 2D video coding process 200, arranged in accordance with at least some implementations of the present disclosure. In the illustrated implementation, process 300 may include one or more operations, functions or actions as illustrated by one or more of blocks 302, and/or 304. By way of non-limiting example, process 300 will be described herein with reference to example 2D video coding system 200 of FIGS. 2 and/or 6.

Process 300 may be utilized as a computer-implemented method for panorama based 3D video coding. Process 300 may begin at block 302, “DECODE PANORAMA VIDEO AND PANORAMA MAP GENERATED BASED AT LEAST IN PART ON MULTIPLE TEXTURE VIEWS AND CAMERA PARAMETERS”, where panorama video and panorama maps may be decoded. For example, panorama video and panorama maps that were generated based at least in part on multiple texture views and camera parameters may be decoded via a 2D decoder (not illustrated).

Processing may continue from operation 302 to operation 304, “EXTRACT 3D VIDEO BASED AT LEAST IN PART ON THE GENERATED PANORAMA VIDEO”, where 3D video may be extracted. For example, 3D video may be extracted based at least in part on the generated panorama video and the associated panorama map.

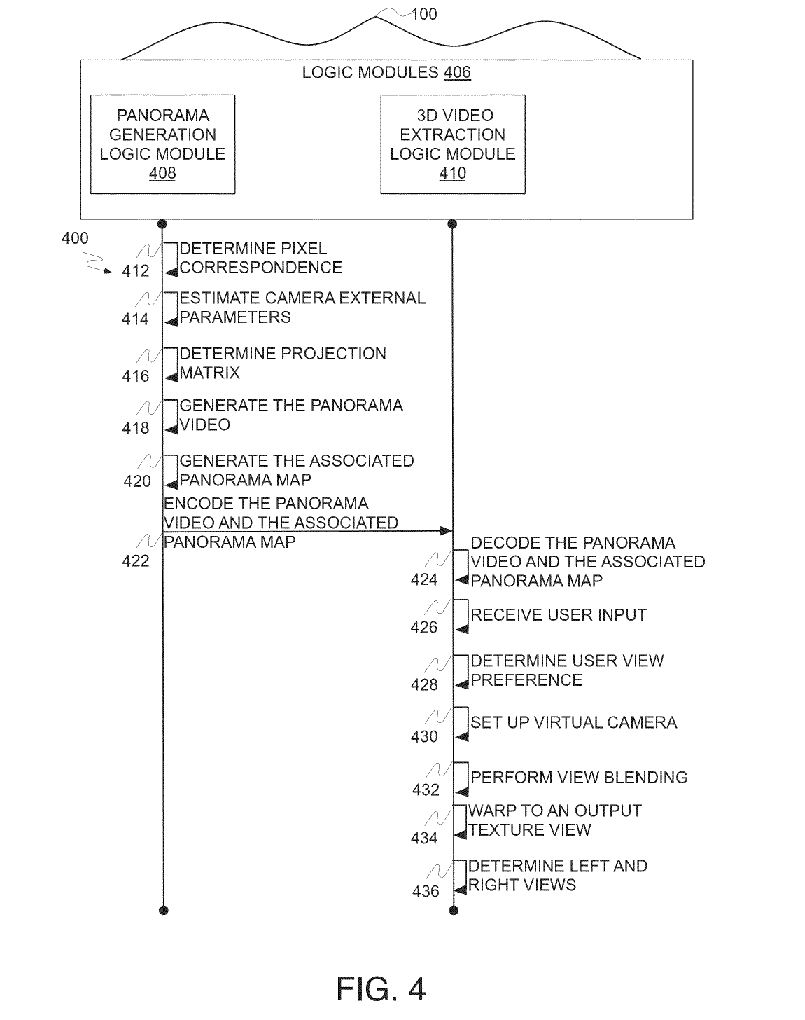

Some additional and/or alternative details related to process 300 may be illustrated in one or more examples of implementations discussed in greater detail below with regard to FIG. 4.

FIG. 4 is an illustrative diagram of example 2D video coding system 200 and 3D video coding process 400 in operation, arranged in accordance with at least some implementations of the present disclosure. In the illustrated implementation, process 400 may include one or more operations, functions or actions as illustrated by one or more of actions 412, 414, 416, 418, 420, 422, 424, 426, 428, 430, 432, 434, and/or 436. By way of non-limiting example, process 400 will be described herein with reference to example 2D video coding system 200 of FIG. 2 and/or 5.

In the illustrated implementation, 2D video coding system 200 may include logic modules 406, the like, and/or combinations thereof. For example, logic modules 406, may include panorama generation logic module 408, 3D video extraction logic module 410, the like, and/or combinations thereof. Although 3D video coding system 100, as shown in FIG. 4, may include one particular set of blocks or actions associated with particular modules, these blocks or actions may be associated with different modules than the particular module illustrated here.

Process 400 may begin at block 412, “DETERMINE PIXEL CORRESPONDENCE”, where a pixel correspondence may be determined. For example, on a 2D encoder side, a pixel correspondence may be determined that is capable of mapping pixel coordinates from the multiple texture views via key point features.

In some examples, during pre-processing by using multiview video and camera parameters, the pixel correspondence (e.g., mathematical relationships) may be established. Such pixel correspondence may be estimated via the matching of key point features like Speeded Up Robust Feature (SURF) or Scale-Invariant Feature Transform (SIFT), for example.

Although process 400, as illustrated, is directed to decoding, the concepts and/or operations described may be applied in the same or similar manner to coding in general, including in encoding.

Processing may continue from operation 412 to operation 414, “ESTIMATE CAMERA EXTERNAL PARAMETERS”, where camera external parameters may be estimated. The camera external parameters may include one or more of the following: a translation vector and a rotation matrix between multiple cameras, the like, and/or combinations thereof.

Processing may continue from operation 414 to operation 416, “DETERMINE PROJECTION MATRIX”, where a projection matrix may be determined. For example, the projection matrix may be determined based at least in part on the camera external parameters and camera internal parameters.

In some examples, the projection matrix P may be established from camera internal parameters (given a priori) and external parameters (e.g., rotation matrix R and translation vector t), as illustrated in the following equation: P=K[R, t], where K is the camera matrix, which contains the scaling factor of the camera, and the optical center of the camera. The projection matrix may map from the 3D scene to the camera view (e.g., raw images).

Processing may continue from operation 416 to operation 418, “GENERATE THE PANORAMA VIDEO”, where the panorama video may be generated. For example, the panorama video may be generated from the multiple texture views via an image stitching algorithm based at least in part on geometric mapping from the determined projection matrix and/or the determined pixel correspondence.

In some examples, the multiple texture views may be captured by various camera setup methods such as parallel camera array, arc camera array, the like, and/or combinations thereof. In such examples, the panorama video may be a cylindrical-type panorama or spherical-type panorama.

Processing may continue from operation 418 to operation 420, “GENERATE THE ASSOCIATED PANORAMA MAP”, where the associated panorama map may be generated. For example, the associated panorama map may be generated and may be capable of mapping pixel coordinates between the multiple texture views and the panorama video as a perspective projection from the multiple texture views to the panorama image.

Processing may continue from operation 420 to operation 422, “ENCODE THE PANORAMA VIDEO AND THE ASSOCIATED PANORAMA MAP”, where the panorama video and the associated panorama map may be encoded. For example, the panorama video and the associated panorama map may be encoded via a 2D encoder (not shown).

Processing may continue from operation 422 to operation 424, “DECODE THE PANORAMA VIDEO AND THE ASSOCIATED PANORAMA MAP”, where the panorama video and the associated panorama map may be decoded. For example, the panorama video and the associated panorama map may be decoded via a 2D decoder (not shown).

In some examples, conventional 2D video encoder/decoder systems may be utilized to code the panorama video and panorama map. The generated panorama video could be coded with MPEG-2, H.264/AVC, HEVC, or other 2D video encoder, for example. Meanwhile, the generated panorama map may be coded and transmitted to decoder through MPEG-2 user data syntax, H.264/AVC SEI syntax table, or HEVC SEI syntax table, for example. Note that the panorama map may contain the projection matrix between camera views, pixel correspondences (e.g., 6˜7) between camera images, and the perspective projection matrix from raw image to panorama video. In this case, the generated 3D bit stream may be compatible with conventional 2D video coding standards. Accordingly, 3D output may be presented to a user without requiring us of a 3D video encoder/decoder system.

Processing may continue from operation 424 to operation 426, “RECEIVE USER INPUT”, where user input may be received. For example, a user may provide input regarding what portion of the panorama view is of interest. In some examples, at the receiver side, video at any arbitrary view position can be selectively decoded by a 2D video decoder. In some examples, such user input may indicate camera internal parameters like field of view, focal-length, etc. and/or external parameters related to existing cameras in the original multi-view video. For instance, the rotation and translation to the first camera in the panorama.

Processing may continue from operation 426 to operation 428, “DETERMINE USER VIEW PREFERENCE”, where the user view preference may be determined. For example, the user view preference may be determined at any arbitrary target view and an associated target region of the panorama video based at least in part on the user input. The user view preference may be defined via one or more of the following criteria: a view direction, viewpoint position, and a field-of-view of a target view, the like, and/or combinations thereof.

Processing may continue from operation 428 to operation 430, “SET UP VIRTUAL CAMERA”, where a virtual camera may be set up. For example, a virtual camera may be set up based at least in part on a prevision configuration on one or more of the following criteria: viewpoint position, field-of-view, and a determined view range in the panorama video.

Processing may continue from operation 430 to operation 432, “PERFORM VIEW BLENDING”, where view blending may be performed. For example, view blending may be performed for the target region of the panorama video when the target region comes from more than a single texture view. In some examples such view blending occurs prior to warping, as illustrated here. Alternatively, such view blending may occur prior to encoding at operation 422.

Processing may continue from operation 432 to operation 434, “WARP TO AN OUTPUT TEXTURE VIEW”, where warping may be done to produce an output texture view. For example, the target region of the panorama video may be warped to an output texture view via 3D warping techniques based at least in part on camera parameters of the virtual camera and the associated panorama map.

Processing may continue from operation 434 to operation 436, “DETERMINE LEFT AND RIGHT VIEWS”, where left and right views may be determined. For example, a left and right view may be determined for the 3D video based at least in part on the output texture view. Accordingly, to provide viewers with a realistic 3D scene perception at an arbitrary view point, such left view and right view may be derived and then shown to each eye simultaneously.

The 3D video may be displayed at the user view preference based at least in part on the determined left and right view via a 3D display (not shown).

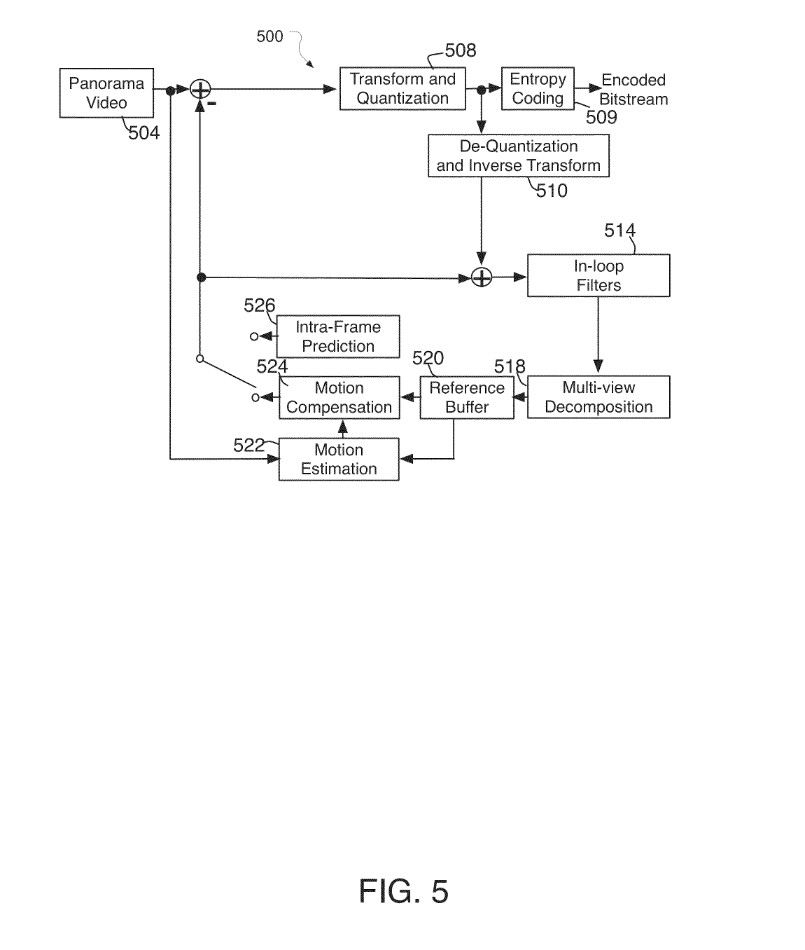

Additionally or alternatively, inter-picture prediction of other panorama video may be performed based at least in part on the output texture view, as will be described in greater detail below with reference to FIG. 5. For example, a modified 2D video coder may decompose the coded panorama video into multiple view pictures, and then the decomposed multiple view pictures could be inserted into a reference buffer for the inter-prediction of other panorama pictures. In such an example, an in-loop decomposition module could improve coding efficiency by producing extra reference frames from the panorama video and panorama map, for example.

In operation, process 400 (and/or process 300) may perform panorama based video coding to improve video coding efficiency, such as the coding efficiency of a 3D video codec and/or a multi-view video codec. Process 400 (and/or process 300) may generate the panorama video sequence via the multiple view sequences and the corresponding camera internal/external parameters. Process 400 (and/or process 300) may convert the 3D video or multi-view videos into a panorama video and a panorama map for encoding and transmission. And at the decoder side, the decoded panorama video may be decomposed into multiple view videos using the decoded panorama map information.

In operation, process 400 (and/or process 300) may be advantageous as compared with the existing 3D video coding methods. For example, process 400 (and/or process 300) may decrease data redundancy and communication traffic in the channel. To be specific, the traditional multiview video coding (MVC) encodes all the input views one by one. Although inter-view prediction and intra-view prediction are exploited in MVC to reduce the redundancies, the residual data after prediction are still much larger than panorama video.

In another example, process 400 (and/or process 300) may generate a bitstream that could, in some implementations, be totally compatible with traditional 2D encoder/decoder without modification to the 2D encoder/decoder. In some implementations, no hardware changes would be taken to support such panorama based 3D video coding. Whereas in the traditional 3D video coding like MVC or currently on-going 3DV standard (e.g., using multiview plus depth 3D video format), the dependent views may not be compatible with traditional 2D encoder/decoder due to the inter-view prediction.

In a further example, process 400 (and/or process 300) may supports head motion parallax while MVC cannot support such a feature. By using the presented panorama based 3D video coding, an arbitrary view video at any intermediate viewing position can be derived from the panorama video by process 400 (and/or process 300). However, such a number of output views cannot be varied in MVC (only decreased).

In a still further example, process 400 (and/or process 300) may not need to encode the depth maps of multiple views. The currently ongoing 3DV standardization typically encodes multiview plus depth 3D video format. Nevertheless, the derivation of depth map is still an obscure point. The existing depth sensor and depth estimation algorithm still needs to be developed to achieve a high quality depth map in such currently ongoing 3DV standardization methods.

In a still further example, process 400 (and/or process 300) may employ an in-loop multi-view decomposition module by producing an extra reference frame from the panorama video and the panorama map. Since the extracted multiview video may be produced via view blending and 3D warping techniques, the visual quality may be maintained at a high level. Therefore, the coding efficiency may be further improved by adding the panorama-based reference frame.

While implementation of example processes 300 and 400, as illustrated in FIGS. 3 and 4, may include the undertaking of all blocks shown in the order illustrated, the present disclosure is not limited in this regard and, in various examples, implementation of processes 300 and 400 may include the undertaking only a subset of the blocks shown and/or in a different order than illustrated.

In addition, any one or more of the blocks of FIGS. 3 and 4 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 3 and 4 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

FIG. 5 is an illustrative diagram of example panorama based 3D video coding flow of a modified 2D video coder 500 in accordance with at least some implementations of the present disclosure. In the illustrated implementation, inter-picture prediction of other panorama video may be performed via modified 2D video coder 500 based at least in part on the output texture view, as was discussed above in FIG. 4.

For example, panorama video 504 may be passed to a transform and quantization module 508. Transform and quantization module 508 may perform known video transform and quantization processes. The output of transform and quantization module 508 may be provided to an entropy coding module 509 and to a de-quantization and inverse transform module 510. De-quantization and inverse transform module 510 may implement the inverse of the operations undertaken by transform and quantization module 508 to provide the output of panorama video 504 to in loop filters 514 (e.g., including a de-blocking filter, a sample adaptive offset filter, an adaptive loop filter, or the like), a buffer 520, a motion estimation module 522, a motion compensation module 524 and an intra-frame prediction module 526. Those skilled in the art may recognize that transform and quantization modules and de-quantization and inverse transform modules as described herein may employ scaling techniques. The output of loop filters 514 may be fed back to multi-view decomposition module 518.

Accordingly, in some embodiments, the panorama video could be encoded using modified 2D video coder 500, as shown in FIG. 5. At the encoder/decoder side, in-loop multi-view decomposition module 518 may be applied to extract multiview pictures from coded the panorama video and panorama map. Then, to improve the coding efficiency, the extracted multi-view pictures could be inserted into reference buffer 520 for the inter-prediction of other panorama pictures. For example, modified 2D video coder 500 may decompose the coded panorama video into multiple view pictures, and then the decomposed multiple view pictures could be inserted into reference buffer 520 for the inter-prediction of other panorama pictures. In such an example, in-loop decomposition module 518 could improve coding efficiency by producing extra reference frames from the panorama video and panorama map, for example.

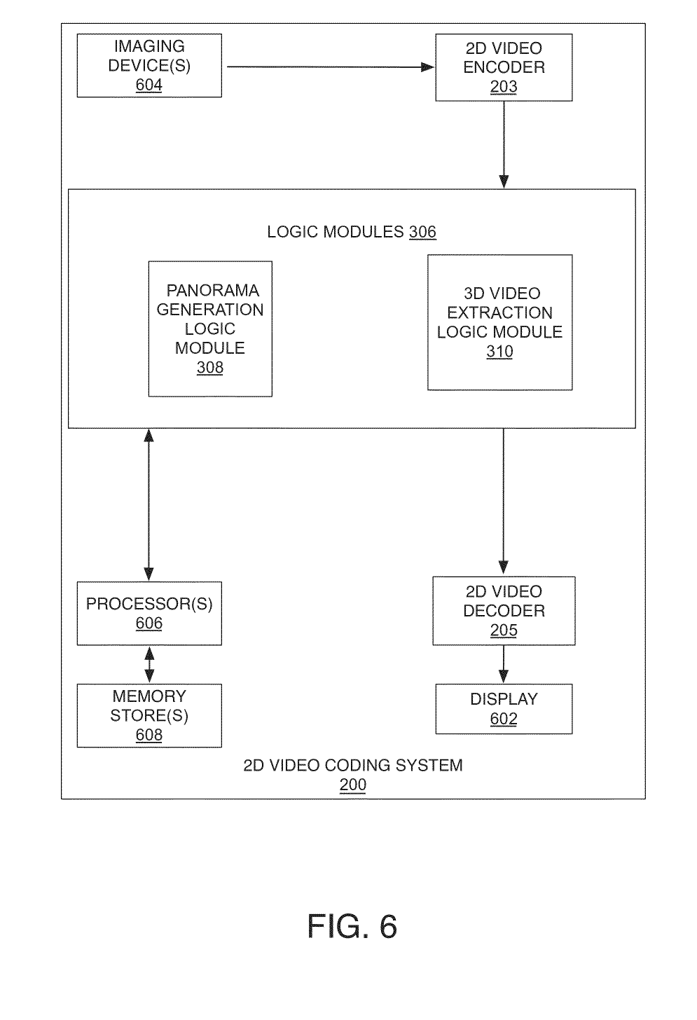

FIG. 6 is an illustrative diagram of an example 2D video coding system 200, arranged in accordance with at least some implementations of the present disclosure. In the illustrated implementation, 2D video coding system 200 may include display 602, imaging device(s) 604, 2D video encoder 203, 2D video decoder 205, and/or logic modules 406. Logic modules 406 may include panorama generation logic module 408, 3D video extraction logic module 410, the like, and/or combinations thereof.

As illustrated, display 602, 2D video decoder 205, processor 606 and/or memory store 608 may be capable of communication with one another and/or communication with portions of logic modules 406. Similarly, imaging device(s) 604 and 2D video encoder 203 may be capable of communication with one another and/or communication with portions of logic modules 406. Accordingly, 2D video decoder 205 may include all or portions of logic modules 406, while 2D video encoder 203 may include similar logic modules. Although 2D video coding system 200, as shown in FIG. 6, may include one particular set of blocks or actions associated with particular modules, these blocks or actions may be associated with different modules than the particular module illustrated here.

In some examples, display device 602 may be configured to present video data. Processors 606 may be communicatively coupled to display device 602. Memory stores 608 may be communicatively coupled to processors 606. Panorama generation logic module 408 may be communicatively coupled to processors 606 and may be configured to generate panorama video and panorama maps. 2D encoder 203 may be communicatively coupled to panorama generation logic module 408 and may be configured to encode the panorama video and the associated panorama map. 2D decoder 205 may be communicatively coupled to 2D encoder 203 and may be configured to decode a panorama video and an associated panorama map, where the panorama video and the associated panorama map were generated based at least in part on multiple texture views and camera parameters. 3D video extraction logic module 410 may be communicatively coupled to 2D decoder 205 and may be configured to extract a 3D video based at least in part on the panorama video and the associated panorama map.

In various embodiments, panorama generation logic module 408 may be implemented in hardware, while software may implement 3D video extraction logic module 410. For example, in some embodiments, panorama generation logic module 408 may be implemented by application-specific integrated circuit (ASIC) logic while 3D video extraction logic module 410 may be provided by software instructions executed by logic such as processors 606. However, the present disclosure is not limited in this regard and panorama generation logic module 408 and/or 3D video extraction logic module 410 may be implemented by any combination of hardware, firmware and/or software. In addition, memory stores 608 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 608 may be implemented by cache memory.

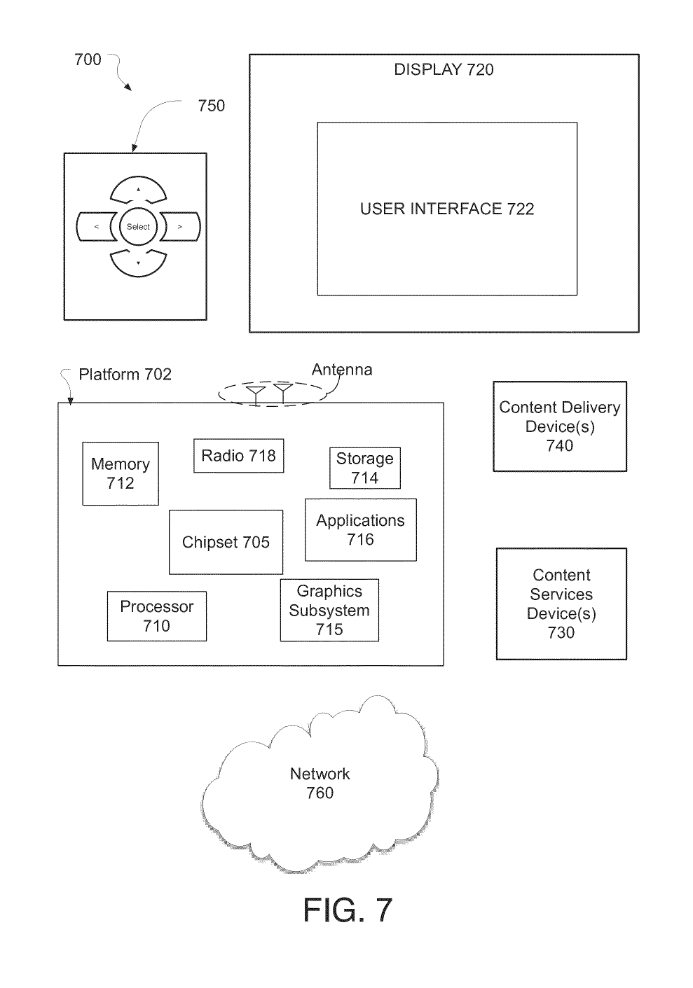

FIG. 7 illustrates an example system 700 in accordance with the present disclosure. In various implementations, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 700 includes a platform 702 coupled to a display 720. Platform 702 may receive content from a content device such as content services device(s) 730 or content delivery device(s) 740 or other similar content sources. A navigation controller 750 including one or more navigation features may be used to interact with, for example, platform 702 and/or display 720. Each of these components is described in greater detail below.

In various implementations, platform 702 may include any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 710 may be dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 714 may include technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, Display Port, wireless HDMI, and/or wireless HD compliant techniques. Graphics subsystem 715 may be integrated into processor 710 or chipset 705. In some implementations, graphics subsystem 715 may be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 718 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In various implementations, display 720 may include any television type monitor or display. Display 720 may include, for example, a computer display screen, touch screen display, video monitor, television-like device, and/or a television. Display 720 may be digital and/or analog. In various implementations, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In various implementations, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In various implementations, content services device(s) 730 may include a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be replicated on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but may be integrated into platform 702 and/or display 720. The present disclosure, however, is not limited to the elements or in the context shown or described herein.

In various implementations, drivers (not shown) may include technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 even when the platform is turned “off.” In addition, chipset 705 may include hardware and/or software support for (6.1) surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 600 may be integrated. For example, platform 602 and content services device(s) 630 may be integrated, or platform 602 and content delivery device(s) 640 may be integrated, or platform 602, content services device(s) 630, and content delivery device(s) 640 may be integrated, for example. In various embodiments, platform 602 and display 620 may be an integrated unit. Display 620 and content service device(s) 630 may be integrated, or display 620 and content delivery device(s) 640 may be integrated, for example. These examples are not meant to limit the present disclosure.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

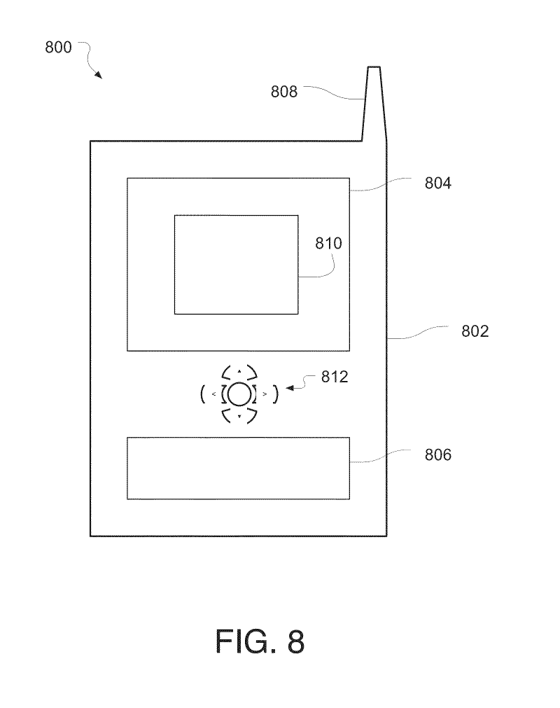

As described above, system 600 may be embodied in varying physical styles or form factors. FIG. 8 illustrates implementations of a small form factor device 800 in which system 600 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may include a housing 802, a display 804, an input/output (I/O) device 806, and an antenna 808. Device 800 also may include navigation features 812. Display 804 may include any suitable display unit for displaying information appropriate for a mobile computing device. I/O device 806 may include any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer-implemented method for video coding may include decoding a panorama video and an associated panorama map, via a 2D decoder. The panorama video and the associated panorama map may have been generated based at least in part on multiple texture views and camera parameters. A 3D video may be extracted based at least in part on the panorama video and the associated panorama map.

In another example, a computer-implemented method for video coding may further include, on a 2D encoder side, determining a pixel correspondence capable of mapping pixel coordinates from the multiple texture views via key point features. Camera external parameters may be estimated, where the camera external parameters include one or more of the following: a translation vector and a rotation matrix between multiple cameras. A projection matrix may be determined based at least in part on the camera external parameters and camera internal parameters. The panorama video may be generated from the multiple texture views via an image stitching algorithm based at least in part on geometric mapping from the determined projection matrix and/or the determined pixel correspondence. The associated panorama map may be generated an may be capable of mapping pixel coordinates between the multiple texture views and the panorama video as a perspective projection from the multiple texture views to the panorama image. The panorama video and the associated panorama map may be encoded. On the 2D decoder side, the extraction of the 3D video may further include receiving user input. A user view preference may be determined at any arbitrary target view and an associated target region of the panorama video based at least in part on the user input, where the user view preference may be defined via one or more of the following criteria: a view direction, viewpoint position, and a field-of-view of a target view. A virtual camera may be set up based at least in part on a prevision configuration on one or more of the following criteria: viewpoint position, field-of-view, and a determined view range in the panorama video. View blending may be performed for the target region of the panorama video when the target region comes from more than a single texture view, where the view blending occurs prior to warping or prior to encoding. The target region of the panorama video may be warped to an output texture view via 3D warping techniques based at least in part on camera parameters of the virtual camera and the associated panorama map. A left and right view may be determined for the 3D video based at least in part on the output texture view. The 3D video may be displayed at the user view preference based at least in part on the determined left and right view. Inter-picture prediction of other panorama video may be performed based at least in part on the output texture view.

In other examples, a system for video coding on a computer may include a display device, one or more processors, one or more memory stores, a 2D decoder, a 3D video extraction logic module, the like, and/or combinations thereof. The display device may be configured to present video data. The one or more processors may be communicatively coupled to the display device. The one or more memory stores may be communicatively coupled to the one or more processors. The 2D decoder may be communicatively coupled to the one or more processors and may be configured to decode a panorama video and an associated panorama map, where the panorama video and the associated panorama map were generated based at least in part on multiple texture views and camera parameters. The 3D video extraction logic module may be communicatively coupled to the 2D decoder and may be configured to extract a 3D video based at least in part on the panorama video and the associated panorama map.

In another example, the system for video coding on a computer may further include a panorama generation logic module configured to determine a pixel correspondence capable of mapping pixel coordinates from the multiple texture views via key point features; estimate camera external parameters, where the camera external parameters include one or more of the following: a translation vector and a rotation matrix between multiple cameras; determine a projection matrix based at least in part on the camera external parameters and camera internal parameters; generate the panorama video from the multiple texture views via an image stitching algorithm based at least in part on geometric mapping from the determined projection matrix and/or the determined pixel correspondence; and generate the associated panorama map capable of mapping pixel coordinates between the multiple texture views and the panorama video as a perspective projection from the multiple texture views to the panorama image. The system may further include a 2D encoder configured to encode the panorama video and the associated panorama map. The 3D video extraction logic module may be further configured to receive user input and determine a user view preference at any arbitrary target view and an associated target region of the panorama video based at least in part on the user input, where the user view preference may be defined via one or more of the following criteria: a view direction, viewpoint position, and a field-of-view of a target view. The 3D video extraction logic module may be further configured to set up a virtual camera based at least in part on a prevision configuration on one or more of the following criteria: viewpoint position, field-of-view, and a determined view range in the panorama video; perform view blending for the target region of the panorama video when the target region comes from more than a single texture view, where the view blending occurs prior to warping or prior to encoding; warp the target region of the panorama video to an output texture view via 3D warping techniques based at least in part on camera parameters of the virtual camera and the associated panorama map; and determine a left and right view for the 3D video based at least in part on the output texture view. The display may be further configured to display the 3D video at the user view preference based at least in part on the determined left and right view. The 2D decoder may be further configured to perform inter-picture prediction of other panorama video based at least in part on the output texture view.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

1-26. (canceled)

27. A computer-implemented method for video coding, comprising:
decoding a panorama video and an associated panorama map, via a 2D decoder, wherein the panorama video and the associated panorama map were generated based at least in part on multiple texture views and camera parameters; and
extracting a 3D video based at least in part on the panorama video and the associated panorama map.

28. The method of claim 27, wherein the extraction of the 3D video further comprises:
warping the target region of the panorama video to an output texture view via 3D warping techniques based at least in part on the associated panorama map;
determining a left and right view for the 3D video based at least in part on the output texture view; and
displaying the 3D video at the user view preference based at least in part on the determined left and right view.

29. The method of claim 27, wherein the extraction of the 3D video further comprises:
warping the target region of the panorama video to an output texture view via 3D warping techniques based at least in part on the associated panorama map; and
performing inter-picture prediction of other panorama video based at least in part on the output texture view.

30. The method of claim 27, wherein the extraction of the 3D video further comprises:
receiving user input;
determining a user view preference at any arbitrary target view and an associated target region of the panorama video based at least in part on the user input;
setting up a virtual camera based at least in part on the user view preference; and
warping the target region of the panorama video to an output texture view via 3D warping techniques based at least in part on camera parameters of the virtual camera and the associated panorama map.

31. The method of claim 27, wherein the extraction of the 3D video further comprises:
receiving user input;
determining a user view preference at any arbitrary target view and an associated target region of the panorama video based at least in part on the user input, wherein the user view preference may be defined via one or more of the following criteria: a view direction, viewpoint position, and a field-of-view of a target view;
setting up a virtual camera based at least in part on a prevision configuration on one or more of the following criteria: viewpoint position, field-of-view, and a determined view range in the panorama video; and
warping the target region of the panorama video to an output texture view via 3D warping techniques based at least in part on camera parameters of the virtual camera and the associated panorama map.

32. The method of claim 27, wherein the extraction of the 3D video further comprises:
performing view blending for the panorama video.

33. The method of claim 27, wherein the extraction of the 3D video further comprises:
receiving user input;
determining a user view preference at any arbitrary target view and an associated target region of the panorama video based at least in part on the user input, wherein the user view preference may be defined via one or more of the following criteria: a view direction, viewpoint position, and a field-of-view of a target view;
setting up a virtual camera based at least in part on a prevision configuration on one or more of the following criteria: viewpoint position, field-of-view, and a determined view range in the panorama video;
performing view blending for the target region of the panorama video when the target region comes from more than a single texture view, wherein the view blending occurs prior to warping or prior to encoding;
warping the target region of the panorama video to an output texture view via 3D warping techniques based at least in part on camera parameters of the virtual camera and the associated panorama map;
determining a left and right view for the 3D video based at least in part on the output texture view;
displaying the 3D video at the user view preference based at least in part on the determined left and right view; and
performing inter-picture prediction of other panorama video based at least in part on the output texture view.

34. The method of claim 27, wherein generation of the panorama video and the associated panorama map comprises:
generating the panorama video from the multiple texture views via an image stitching algorithm; and
generating the associated panorama map capable of mapping pixel coordinates between the multiple texture views and the panorama video as a perspective projection from the multiple texture views to the panorama image.

35. The method of claim 27, wherein generation of the panorama video and the associated panorama map comprises:
generating the panorama video from the multiple texture views via an image stitching algorithm based at least in part on a determined projection matrix and a determined pixel correspondence;
generating the associated panorama map capable of mapping pixel coordinates between the multiple texture views and the panorama video as a perspective projection from the multiple texture views to the panorama image; and
encoding the panorama video and the associated panorama map.

36. The method of claim 27, wherein generation of the panorama video and the associated panorama map comprises:
determining a pixel correspondence capable of mapping pixel coordinates from the multiple texture views via key point features;
determining a projection matrix based at least in part on the camera external parameters and camera internal parameters;
generating the panorama video from the multiple texture views via an image stitching algorithm based at least in part on geometric mapping from the determined projection matrix and/or the determined pixel correspondence;
generating the associated panorama map capable of mapping pixel coordinates between the multiple texture views and the panorama video as a perspective projection from the multiple texture views to the panorama image; and
encoding the panorama video and the associated panorama map.

37. The method of claim 27, wherein generation of the panorama video and the associated panorama map comprises:
determining a pixel correspondence capable of mapping pixel coordinates from the multiple texture views via key point features;
estimating camera external parameters, wherein the camera external parameters comprise one or more of the following: a translation vector and a rotation matrix between multiple cameras;
determining a projection matrix based at least in part on the camera external parameters and camera internal parameters;
generating the panorama video from the multiple texture views via an image stitching algorithm based at least in part on geometric mapping from the determined projection matrix and/or the determined pixel correspondence;
generating the associated panorama map capable of mapping pixel coordinates between the multiple texture views and the panorama video as a perspective projection from the multiple texture views to the panorama image; and
encoding the panorama video and the associated panorama map.

38. The method of claim 27, further comprising:
on a 2D encoder side:
determining a pixel correspondence capable of mapping pixel coordinates from the multiple texture views via key point features;
estimating camera external parameters, wherein the camera external parameters comprise one or more of the following: a translation vector and a rotation matrix between multiple cameras;
determining a projection matrix based at least in part on the camera external parameters and camera internal parameters;
generating the panorama video from the multiple texture views via an image stitching algorithm based at least in part on geometric mapping from the determined projection matrix and/or the determined pixel correspondence;
generating the associated panorama map capable of mapping pixel coordinates between the multiple texture views and the panorama video as a perspective projection from the multiple texture views to the panorama image;
encoding the panorama video and the associated panorama map;
on the 2D decoder side, the extraction of the 3D video further comprises:
receiving user input;
determining a user view preference at any arbitrary target view and an associated target region of the panorama video based at least in part on the user input, wherein the user view preference may be defined via one or more of the following criteria: a view direction, viewpoint position, and a field-of-view of a target view;
setting up a virtual camera based at least in part on a prevision configuration on one or more of the following criteria: viewpoint position, field-of-view, and a determined view range in the panorama video;
performing view blending for the target region of the panorama video when the target region comes from more than a single texture view, wherein the view blending occurs prior to warping or prior to encoding;
warping the target region of the panorama video to an output texture view via 3D warping techniques based at least in part on camera parameters of the virtual camera and the associated panorama map;
determining a left and right view for the 3D video based at least in part on the output texture view;
displaying the 3D video at the user view preference based at least in part on the determined left and right view; and
performing inter-picture prediction of other panorama video based at least in part on the output texture view.

39. A system for video coding on a computer, comprising:
a display device configured to present video data;
one or more processors communicatively coupled to the display device;
one or more memory stores communicatively coupled to the one or more processors;
a 2D decoder communicatively coupled to the one or more processors and configured to decode a panorama video and an associated panorama map, wherein the panorama video and the associated panorama map were generated based at least in part on multiple texture views and camera parameters; and
a 3D video extraction logic module communicatively coupled to the 2D decoder and configured to extract a 3D video based at least in part on the panorama video and the associated panorama map.

40. The system of claim 39, wherein the 3D video extraction logic module is further configured to:
warp the target region of the panorama video to an output texture view via 3D warping techniques based at least in part on the associated panorama map;
determine a left and right view for the 3D video based at least in part on the output texture view; and
wherein the display is further configured to display the 3D video at the user view preference based at least in part on the determined left and right view.

41. The system of claim 39, wherein the 3D video extraction logic module is further configured to:
warp the target region of the panorama video to an output texture view via 3D warping techniques based at least in part on the associated panorama map; and
wherein the 2D decoder is further configured to perform inter-picture prediction of other panorama video based at least in part on the output texture view.

42. The system of claim 39, wherein the 3D video extraction logic module is further configured to:
receive user input;
determine a user view preference at any arbitrary target view and an associated target region of the panorama video based at least in part on the user input;
set up a virtual camera based at least in part on the user view preference; and
warp the target region of the panorama video to an output texture view via 3D warping techniques based at least in part on camera parameters of the virtual camera and the associated panorama map.

43. The system of claim 39, wherein the 3D video extraction logic module is further configured to:
receive user input;
determine a user view preference at any arbitrary target view and an associated target region of the panorama video based at least in part on the user input, wherein the user view preference may be defined via one or more of the following criteria: a view direction, viewpoint position, and a field-of-view of a target view;
set up a virtual camera based at least in part on a prevision configuration on one or more of the following criteria: viewpoint position, field-of-view, and a determined view range in the panorama video; and
warp the target region of the panorama video to an output texture view via 3D warping techniques based at least in part on camera parameters of the virtual camera and the associated panorama map.

44. The system of claim 39, wherein the 3D video extraction logic module is further configured to:
perform view blending for the panorama video.

45. The system of claim 39, wherein the 3D video extraction logic module is further configured to:
receive user input;
determine a user view preference at any arbitrary target view and an associated target region of the panorama video based at least in part on the user input, wherein the user view preference may be defined via one or more of the following criteria: a view direction, viewpoint position, and a field-of-view of a target view;
set up a virtual camera based at least in part on a prevision configuration on one or more of the following criteria: viewpoint position, field-of-view, and a determined view range in the panorama video;
perform view blending for the target region of the panorama video when the target region comes from more than a single texture view, wherein the view blending occurs prior to warping or prior to encoding;
warp the target region of the panorama video to an output texture view via 3D warping techniques based at least in part on camera parameters of the virtual camera and the associated panorama map;
determine a left and right view for the 3D video based at least in part on the output texture view;
wherein the display is further configured to display the 3D video at the user view preference based at least in part on the determined left and right view; and
wherein the 2D decoder is further configured to perform inter-picture prediction of other panorama video based at least in part on the output texture view.

46. The system of claim 39, further comprising a panorama generation logic module configured to:
generate the panorama video from the multiple texture views via an image stitching algorithm; and
generate the associated panorama map capable of mapping pixel coordinates between the multiple texture views and the panorama video as a perspective projection from the multiple texture views to the panorama image.

47. The system of claim 39, further comprising a panorama generation logic module configured to:
generate the panorama video from the multiple texture views via an image stitching algorithm based at least in part on a determined projection matrix and a determined pixel correspondence;
generate the associated panorama map capable of mapping pixel coordinates between the multiple texture views and the panorama video as a perspective projection from the multiple texture views to the panorama image; and
the system further comprising a 2D encoder configured to encode the panorama video and the associated panorama map.

48. The system of claim 39, further comprising a panorama generation logic module configured to:
determine a pixel correspondence capable of mapping pixel coordinates from the multiple texture views via key point features;
determine a projection matrix based at least in part on the camera external parameters and camera internal parameters;
generate the panorama video from the multiple texture views via an image stitching algorithm based at least in part on geometric mapping from the determined projection matrix and/or the determined pixel correspondence;
generate the associated panorama map capable of mapping pixel coordinates between the multiple texture views and the panorama video as a perspective projection from the multiple texture views to the panorama image; and
the system further comprising a 2D encoder configured to encode the panorama video and the associated panorama map.

49. The system of claim 39, further comprising a panorama generation logic module configured to:
determine a pixel correspondence capable of mapping pixel coordinates from the multiple texture views via key point features;
estimate camera external parameters, wherein the camera external parameters comprise one or more of the following: a translation vector and a rotation matrix between multiple cameras;
determine a projection matrix based at least in part on the camera external parameters and camera internal parameters;
generate the panorama video from the multiple texture views via an image stitching algorithm based at least in part on geometric mapping from the determined projection matrix and/or the determined pixel correspondence;
generate the associated panorama map capable of mapping pixel coordinates between the multiple texture views and the panorama video as a perspective projection from the multiple texture views to the panorama image; and
the system further comprising a 2D encoder configured to encode the panorama video and the associated panorama map.

50. The system of claim 39, further comprising a panorama generation logic module configured to:
determine a pixel correspondence capable of mapping pixel coordinates from the multiple texture views via key point features;
estimate camera external parameters, wherein the camera external parameters comprise one or more of the following: a translation vector and a rotation matrix between multiple cameras;
determine a projection matrix based at least in part on the camera external parameters and camera internal parameters;
generate the panorama video from the multiple texture views via an image stitching algorithm based at least in part on geometric mapping from the determined projection matrix and/or the determined pixel correspondence;
generate the associated panorama map capable of mapping pixel coordinates between the multiple texture views and the panorama video as a perspective projection from the multiple texture views to the panorama image;
the system further comprising a 2D encoder configured to encode the panorama video and the associated panorama map;
wherein the 3D video extraction logic module is further configured to:
receive user input;
determine a user view preference at any arbitrary target view and an associated target region of the panorama video based at least in part on the user input, wherein the user view preference may be defined via one or more of the following criteria: a view direction, viewpoint position, and a field-of-view of a target view;
set up a virtual camera based at least in part on a prevision configuration on one or more of the following criteria: viewpoint position, field-of-view, and a determined view range in the panorama video;
perform view blending for the target region of the panorama video when the target region comes from more than a single texture view, wherein the view blending occurs prior to warping or prior to encoding;
warp the target region of the panorama video to an output texture view via 3D warping techniques based at least in part on camera parameters of the virtual camera and the associated panorama map;
determine a left and right view for the 3D video based at least in part on the output texture view;
wherein the display is further configured to display the 3D video at the user view preference based at least in part on the determined left and right view; and
wherein the 2D decoder is further configured to perform inter-picture prediction of other panorama video based at least in part on the output texture view.
